(19) United States
(12) Patent Application Publication
(10) Pub. No.: US 2026/0148185 A1
(43) Pub. Date: May 28, 2026

(54) SYSTEM AND METHOD FOR MANAGING USED BOAT INVENTORY AND DISPLAYING INVENTORY METRICS ON A GRAPHICAL USER INTERFACE (GUI)

(71) Applicant: Off the Hook Yacht Sales NC, LLC, Wilmington, NC (US)

(72) Inventors: Jason D. Ruegg, Wilmington, NC (US); Kelly Brintle, Carolina Beach, NC (US)

(21) Appl. No.: 18/961,850

(22) Filed: Nov. 27, 2024

(51) Int. Cl. G06Q 10/087; G06Q 30/0202

(52) U.S. Cl. CPC G06Q 10/087; G06Q 10/08726; G06Q 30/0202

(57) ABSTRACT

The subject matter described herein includes a system for tracking and managing boat inventory through a user interface including a processor configured to track data related to the purchase and sale of boats, cash in boats, money in floorplans, and investor funds, and to update and display visual summaries of wholesale, leads, bids, and incoming and outgoing boats for each broker. The processor is also configured to execute instructions for generating a dashboard view comprising visual metrics and dynamic bar charts and manage separate data categories through multiple interface tabs, including contacts, sales, inventory, alerts, and reports. A user interface allows brokers to input and review boat inventory data, with automated updates to the dashboard for real-time tracking.

### TECHNICAL FIELD

The present invention relates to customer relationship management (CRM) software systems and, more particularly, to a system and method for managing used boat inventory and displaying inventory metrics on a graphical user interface (GUI).

### BACKGROUND

Managing used boat inventory presents unique challenges due to the variability in boat models, conditions, and market demand. Traditional CRM systems often lack industry-specific functionalities required for efficient inventory management, sales tracking, and customer relationship enhancement in the used boat sector. There is a need for an integrated system that addresses these specific requirements, providing a comprehensive solution for brokers and dealers

Accordingly, there is a need for improved methods and systems for managing used boat inventory and displaying inventory metrics on a graphical user interface.

### SUMMARY

Disclosed within are methods, devices, and systems for a CRM software system tailored for the used boat industry. It offers an integrated platform that enables users, such as brokers and administrators, to efficiently manage inventory records, track sales opportunities, and access various functionalities through an intuitive dashboard interface. Key features include customizable dashboards, predictive analytics, real-time data synchronization with external platforms, task management tools, training modules, and advanced visualization options.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

The present embodiments are illustrated by way of example and are not intended to be limited by the figures of the accompanying drawings. In the drawings:

FIG. 1 is a screenshot of a dashboard GUI according to an embodiment of the subject matter described herein.

FIG. 2 is a screenshot of a dashboard GUI according to an embodiment of the subject matter described herein.

FIG. 3 is a screenshot of a dashboard GUI according to an embodiment of the subject matter described herein.

FIG. 4 is a screenshot of a dashboard GUI according to an embodiment of the subject matter described herein.

FIG. 5 is a screenshot of a dashboard GUI according to an embodiment of the subject matter described herein.

FIG. 6 is a screenshot of a dashboard GUI according to an embodiment of the subject matter described herein.

FIG. 7 is a screenshot of a dashboard GUI according to an embodiment of the subject matter described herein.

FIG. 8 is a screenshot of a dashboard GUI according to an embodiment of the subject matter described herein.

FIG. 9 depicts a block diagram 900 illustrating a server 902 as one example for implementing the methods in the present disclosure in accordance with embodiments of the present disclosure.

FIG. 10 depicts a flowchart illustrating the method steps for managing used boat inventory and displaying inventory metrics on a GUI in accordance with embodiments of the present disclosure.

### DETAILED DESCRIPTION

The present invention is a CRM software system comprising a processor and a memory storing instructions. When executed by the processor, these instructions perform functions related to managing used boat inventory and displaying inventory metrics on a GUI. The system enhances user experience by providing an intuitive dashboard, enabling efficient navigation and access to various modules designed to streamline inventory management and sales processes.

The described system and method provide a robust solution for managing used boat inventory and enhancing customer relationship management. By integrating comprehensive data management, user-friendly interfaces, and advanced functionalities such as predictive analytics and real-time synchronization, the invention addresses the specific needs of the industry and offers significant improvements over traditional systems.

The subject matter described herein includes a system for managing used boat inventory records by tracking and displaying inventory metrics. The system has a memory and a processor configured to perform several steps. It creates an inventory record for each boat in inventory, containing data such as purchase date, purchase price, current status, and assigned broker. For example, when a new boat enters the inventory, a broker inputs its purchase date and price into the system.

The system adds classification data to each boat, including categories like Wholesale, Leads, Bids, most recent incoming boats, and most recent outgoing boats. This helps brokers and managers categorize boats for easier tracking. For instance, a boat that has just been received would be classified under “most recent incoming boats.”

Financial data is also incorporated for each boat, such as the amount of cash invested, financing details, and investor contributions. This allows for comprehensive financial tracking. For example, if a boat is financed, those details are recorded to monitor outstanding financial obligations.

The system generates bar charts and reports based on the inventory records, displaying metrics for each individual broker over a period of time on a dashboard interface. Brokers can see visual representations of their sales performance, aiding in performance assessment. For instance, a broker might view a bar chart showing the number of boats sold each month over the past year.

It automatically updates the inventory records and the dashboard interface as new data is received, thereby managing the used boat inventory efficiently. When a sale is made or a new boat is added, the system reflects these changes in real time. This ensures that all users have access to the most current information.

The system provides navigation through a set of tabs including Contacts, Sales, Inventory, Alerts, Reports, Users, Tasks, Marketing, Settings, Requests, Training, and Logs. Each tab leads to a separate page with specific functionality. For example, selecting the “Sales” tab allows a broker to view and manage all current sales opportunities.

In one embodiment, the processor is configured to generate predictive analytics based on historical inventory data to forecast future sales and inventory needs. This helps the business plan for demand fluctuations. For instance, if the system identifies a trend of increased sales for certain boat models during summer months, it can recommend stocking more of those models before the season starts.

In one embodiment, the Reports tab provides customizable reporting tools that allow users to create and save custom reports based on selected inventory metrics and time periods. A manager might create a report showing the performance of all brokers over the last quarter, which can be saved and updated regularly.

In one embodiment, the Users tab includes user management functionality that allows administrators to assign roles and permissions to different users of the system. For example, new brokers can be given access only to the Inventory and Sales tabs, while senior staff have broader access.

In one embodiment, the Marketing tab allows users to create and manage marketing campaigns targeting potential buyers based on inventory data. If there's an excess of a particular boat type, the marketing team can design a campaign to promote those boats to interested clients.

In one embodiment, the system includes an integration module configured to synchronize inventory data with external platforms such as online marketplaces or dealer networks. When a boat is added to the inventory, it can automatically be listed on partnered online marketplaces, increasing its exposure.

In one embodiment, the system allows users to customize the dashboard interface by selecting which inventory metrics and categories are displayed. A broker focused on sales might choose to display metrics related to leads and bids, tailoring the dashboard to their needs.

In one embodiment, the system stores user preferences for the customized dashboard interface and automatically applies them upon user login. This ensures that each user has a personalized experience without needing to adjust settings every time they access the system.

In one embodiment, the Contacts tab provides access to a contact management module that allows users to add, edit, and track interactions with clients, brokers, and investors. A broker can record notes from meetings or calls, maintaining a history of client interactions.

In one embodiment, the Sales tab provides real-time tracking of sales opportunities, including status updates, projected closing dates, and sales pipeline analytics. Brokers can update the status of deals as they progress, providing visibility into the sales pipeline.

In one embodiment, the Alerts tab provides automated notifications to users regarding significant events, including new leads, bids, or changes in inventory status. For example, a broker might receive an alert when a new bid is placed on one of their boats.

The subject matter described herein includes a method of displaying used boat inventory metrics on a graphical user interface (GUI) of a computer system. The method involves receiving, via the GUI, a user selection to display inventory metrics based on specific criteria. These criteria include the number of purchased boats, number of sold boats, amount of cash invested in boats, amount of money in floorplans, and amount of money from investors. For example, a user might select to view metrics for the amount of cash invested over the past six months.

The processor determines the values of each metric over a predetermined period of time. It automatically generates and displays bar charts of the metrics on a dashboard interface of the GUI. These bar charts are displayed for each individual broker over the selected period. A manager can compare the performance of brokers by viewing these visualizations.

The method includes receiving user input to navigate through categories including Wholesale, Leads, Bids, most recent incoming boats, and most recent outgoing boats. The GUI updates to display the selected category's information in the bar charts accordingly. For instance, selecting “Leads” updates the dashboard to focus on new potential sales opportunities.

In one embodiment, the method allows the user to export the displayed inventory metrics and bar charts to a report in a selectable format such as PDF, Excel, or CSV. A broker might export their sales data to an Excel file for further analysis or for sharing with stakeholders.

In one embodiment, determining the values of each metric involves aggregating data from multiple data sources, including internal databases and external market data feeds. This provides a comprehensive view of the market and inventory. For example, external pricing trends can be incorporated to adjust sales strategies.

In one embodiment, the method provides interactive bar charts that allow the user to select a segment of the bar chart to view detailed information about that metric. Clicking on a bar representing sales in a particular month might display a list of all boats sold during that period.

In one embodiment, the method sends automated notifications to brokers when certain inventory metrics reach predefined thresholds. If the number of boats in a specific category drops below a set level, the system alerts the relevant brokers to restock.

In one embodiment, the GUI includes a search function that allows the user to search for specific boats, brokers, or transactions based on user-defined criteria. A user could search for all transactions involving a particular client or for boats within a certain price range.

The subject matter described herein includes a computer-readable medium storing instructions for managing used boat inventory. The instructions involve receiving and storing data related to boat transactions, including data for purchased boats, sold boats, cash in boats, floorplan financing, and investor funds. For example, when a boat is sold, the transaction details are stored for future reference and reporting.

The instructions automatically generate bar charts and visual summaries for wholesale, leads, bids, most recent incoming boats, and most recent outgoing boats for each broker over a specified period. This aids in monitoring performance and inventory levels. Brokers can quickly see how many new leads they've received in the past week.

They provide a user interface with multiple tabs, each designed to display relevant data and metrics for contacts, sales, inventory, alerts, reports, users, tasks, marketing, settings, requests, training, and logs. Each area of the business can access and manage their specific functions. For instance, the training tab might offer resources for new brokers to learn how to use the system effectively.

The instructions enable updates and dynamic visualizations on a dashboard for the tracked metrics. When new data is entered, the dashboard reflects these changes immediately. This ensures that decision-making is based on the most current information.

The subject matter described herein includes a system for tracking and managing boat inventory through a user interface. The system consists of a non-transitory computer-readable medium containing instructions executable by a processor. The instructions are designed to track data related to the purchase and sale of boats, cash in boats, money in floorplans, and investor funds. For example, financial officers can monitor the amount of money tied up in inventory versus what's financed.

They update and display visual summaries of wholesale, leads, bids, incoming, and outgoing boats for each broker. Brokers can see at a glance how many leads they have and how many boats are scheduled to arrive or depart.

The processor is programmed to execute instructions for generating a dashboard view comprising visual metrics and dynamic bar charts. It manages separate data categories through multiple interface tabs, including Contacts, Sales, Inventory, Alerts, and Reports. This organized structure helps users navigate the system efficiently.

The system provides a user interface allowing brokers to input and review boat inventory data, with automated updates to the dashboard for real-time tracking. For instance, when a broker inputs a new lead, the system updates the leads count and adjusts related metrics.

In practice, a broker might start their day by logging into the system to check their dashboard. They can see new alerts for incoming bids or messages from clients. Using the search function, they find details about a specific boat a client is interested in. They can update the status of a potential sale in the Sales tab and set reminders for follow-up actions in the Tasks tab.

By incorporating these features, the system streamlines the management of used boat inventory, enhances communication among brokers and clients, and provides valuable insights through data visualization and analytics.

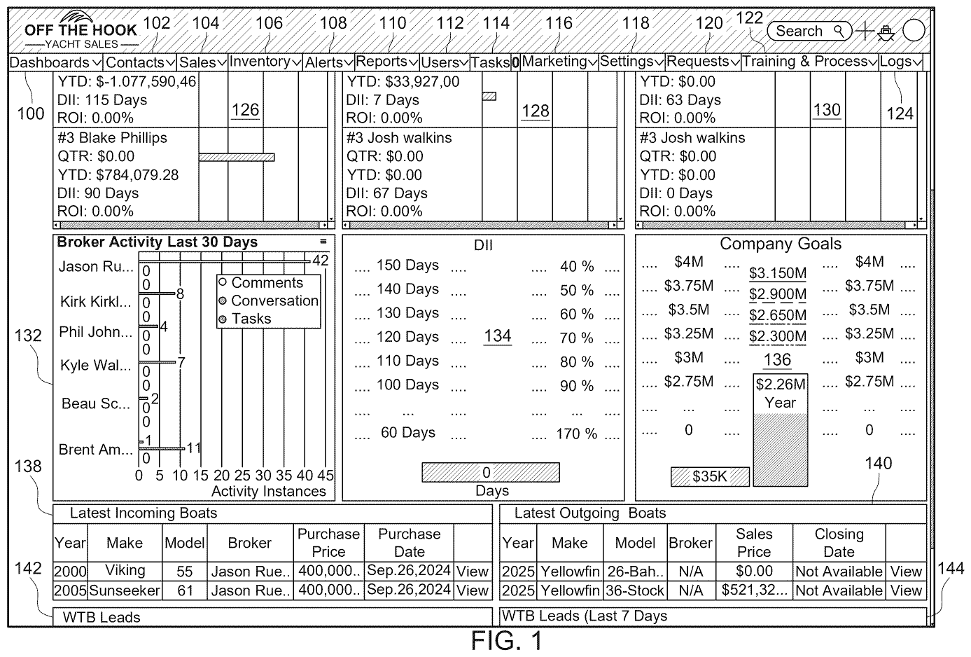

FIG. 1 is a screenshot of a dashboard GUI according to an embodiment of the subject matter described herein. The screenshot shows a web-based dashboard interface, presumably part of a customer relationship management (CRM) or inventory management system for a boat dealership or brokerage. The layout is divided into multiple sections and modules, each providing a distinct set of information related to boat sales, inventory, and broker performance.

At the top of the page, there is a navigation bar with dropdown menus for various tabs, including Dashboard, Contacts, Sales, Inventory, Alerts, Reports, Users, Tasks, Marketing, Settings, Requests, Training & Processes, and Logs. These tabs suggest that the system offers a wide range of functionalities to manage different aspects of the business, including customer interactions, sales opportunities, inventory tracking, and more.

Directly beneath the navigation bar is a section labeled “Overview Dashboard” and “Broker Performance Dashboard.” This section includes key metrics, such as the number of Purchased Boats (currently showing 0), the number of Sold Boats (currently showing 1), Cash in Boats ($2,493,202), Floorplan $ in Boats ($17,742,651), and Investor $ in Boats (currently $0). These metrics provide users with a high-level overview of the financial and inventory status of their operations.

To the right, two vertical bar charts labeled Leads and Bids track broker activity. In the Leads section, a list of brokers is displayed along with the number of leads they have generated. For instance, Brent Ambers has 12 leads, John Parker has 8, and Josh Watkins has 5, among others. Similarly, the Bids section displays a bar chart showing that Andrew Cooper has placed one bid.

In the middle of the dashboard, there is a content section titled The Helm, which displays announcements or updates for the company. In this particular screenshot, there are two updates: one dated Jun. 1, 2024 titled “Omega Seamaster Contest”, and another one titled Q2 2024 Team Goals/Bonuses dated Apr. 1, 2024. These announcements provide company-wide goals and information, such as sales targets or team performance bonuses, along with a “Read More” link for further details.

Below these announcements are three more sections, labeled Wholesale, Brokerage, and New/Build. Each section features a horizontal bar chart, with information on brokers and their sales metrics. For example, under the Wholesale section, brokers such as Phil Johnson and Jason Funder are listed alongside figures like Year-To-Date (YTD) sales, Return on Investment (ROI), and other sales statistics. The Brokerage and New/Build sections are similarly structured, offering data on each broker's performance in these categories, including their YTD and ROI metrics.

At the bottom of the dashboard, there is another chart titled Broker Activity Last 30 Days, which visualizes broker activity over the past month. This section appears to display trends in broker performance, potentially showing the volume of leads, bids, or sales activity over time.

In the top-right corner of the dashboard, there is a user profile icon labeled with the initials WS, indicating the logged-in user. A search bar is also present at the top-right for quick navigation within the system. Additionally, there are icons for adding new entries (such as new sales or inventory records) and accessing notifications or settings.

Overall, this screenshot depicts a feature-rich, data-driven interface designed to provide users with comprehensive insights into sales, inventory, and broker performance within a boat dealership or brokerage context. The system is used by managers and brokers to track ongoing business activities, manage leads and bids, and monitor key financial metrics.

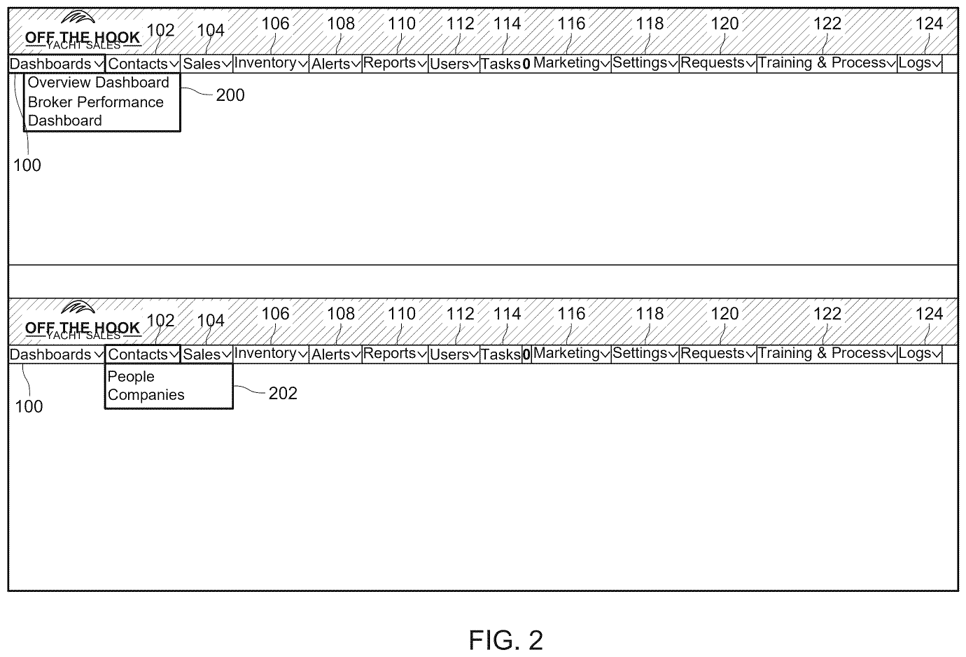

FIG. 2 is a screenshot of a dashboard GUI according to an embodiment of the subject matter described herein. Here, it may be appreciated that hovering the mouse over the Dashboards tab displays a drop-down menu including Overview Dashboard and Broker Performance Dashboard that, when selected, take the user to an interface associated with these items. Additionally, the Contacts tab displays a drop-down menu including People and Companies that, when selected, take the user to an interface associated with these items.

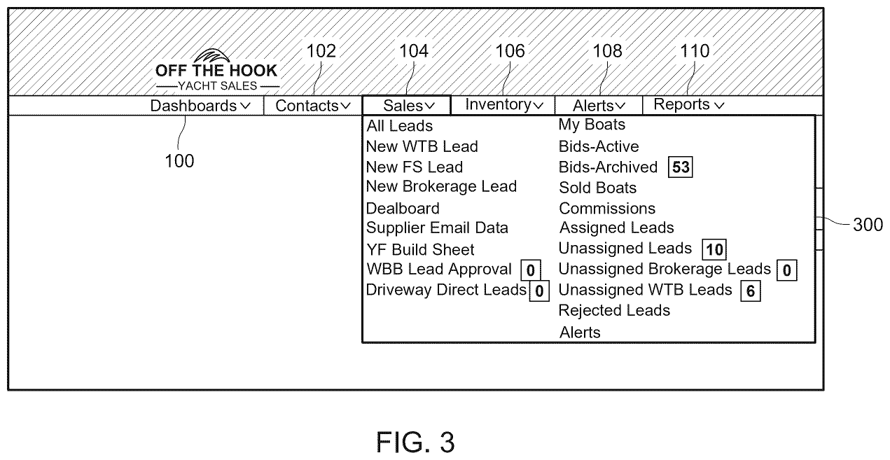

FIG. 3 is a screenshot of a dashboard GUI according to an embodiment of the subject matter described herein. Here, it may be appreciated that hovering the mouse over the Sales tab displays a drop-down menu including All Leads, New WTB Lead, New FS Lead, New Brokerage Lead, Dealboard, Supplier Email Data, YF Build Sheet, WBB Lead Approval, Driveway Direct Leads, My Boats, Bids-Active, Bids-Archived, Sold Boats, Commissions, Assigned Leads, Unassigned Leads, Unassigned Brokerage Leads, Unassigned WTB Leads, Rejected Leads, and Alerts that, when selected, take the user to an interface associated with these items.

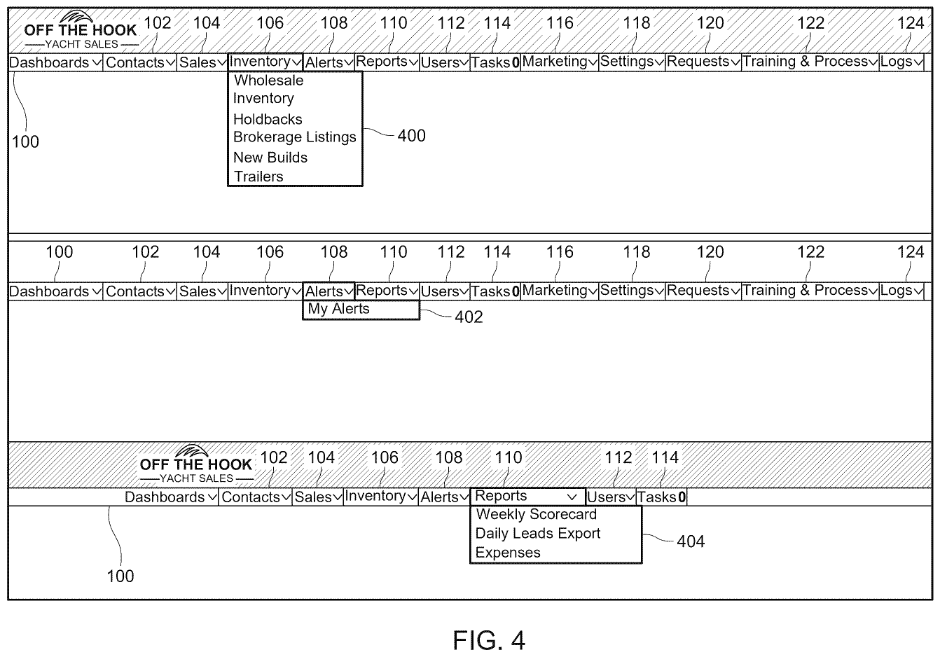

FIG. 4 is a screenshot of a dashboard GUI according to an embodiment of the subject matter described herein. Here, it may be appreciated that hovering the mouse over the Inventory tab displays a drop-down menu including Wholesale Inventory, Holdbacks, Brokerage Listings, New Builds, and Trailers that, when selected, take the user to an interface associated with these items. Additionally, the Reports tab includes selections for Weekly Scorecard, Daily Leads Export, and Expenses.

This screenshot provides a detailed view of the “Sales” dropdown menu within the “Off the Hook Yacht Sales” platform, illustrating a wide range of options and subcategories for sales management. At the top of the interface, the navigation bar maintains the same structure as previous images, with dropdowns for sections like “Dashboards,” “Contacts,” “Sales,” “Inventory,” “Alerts,” and “Reports.” In this screenshot, the “Sales” dropdown menu is expanded, showcasing various options that highlight the platform's capabilities in lead and sales management.

The expanded “Sales” dropdown menu is organized into two columns, each listing categories relevant to different facets of the sales process. The first column includes items such as “All Leads,” which likely provides an overview of all lead activity within the platform. Options like “New WTB Lead” (Want to Buy), “New FS Lead” (For Sale), and “New Brokerage Lead” appear to categorize leads by specific buyer or seller intentions. “Dealboard” may serve as a summary page or pipeline for active deals, while “Supplier Email Data” and “YF Build Sheet” likely offer access to information related to suppliers and manufacturing specifications. Additional items, such as “WBB Lead Approval” and “Driveway Direct Leads” (both showing a count of “0”), suggest specific categories for lead approval and referrals, further supporting the sales workflow.

The second column focuses on tracking and managing the status of boats and bids. Categories here include “My Boats,” which could provide a personalized list of boats associated with the user. The menu also includes “Bids—Active,” showing a count of 53, and “Bids—Archived,” to help users manage ongoing and past bids on listed boats. Additional options like “Sold Boats” and “Commissions” are used to track completed sales and broker earnings. “Assigned Leads” and “Unassigned Leads,” with a count of 10 for unassigned leads, offer an overview of lead allocation status, while “Unassigned Brokerage Leads” and “Unassigned WTB Leads” indicate separate categories for leads needing assignment. Lastly, “Rejected Leads” and “Alerts” provide functionality to monitor inactive or unsuccessful leads and stay informed on critical updates.

Below the navigation bar, the main dashboard area displays the date range “10/01/2024-12/31/2024,” indicating that this screen is focused on tracking quarterly or year-end performance. There's also a “Contest Update” section related to a specific boat, labeled “JUNE *OMEGA SEA,” which highlight promotional or contest-based opportunities. This section includes a brief description with a “Read More” link for additional information.

The interface is designed to streamline yacht sales management by providing options for lead tracking, bid monitoring, and performance metrics. The structured menu supports both high-level sales insights and detailed lead management, ensuring that brokers and sales staff have the tools needed to manage yacht transactions effectively within a cohesive, user-friendly environment.

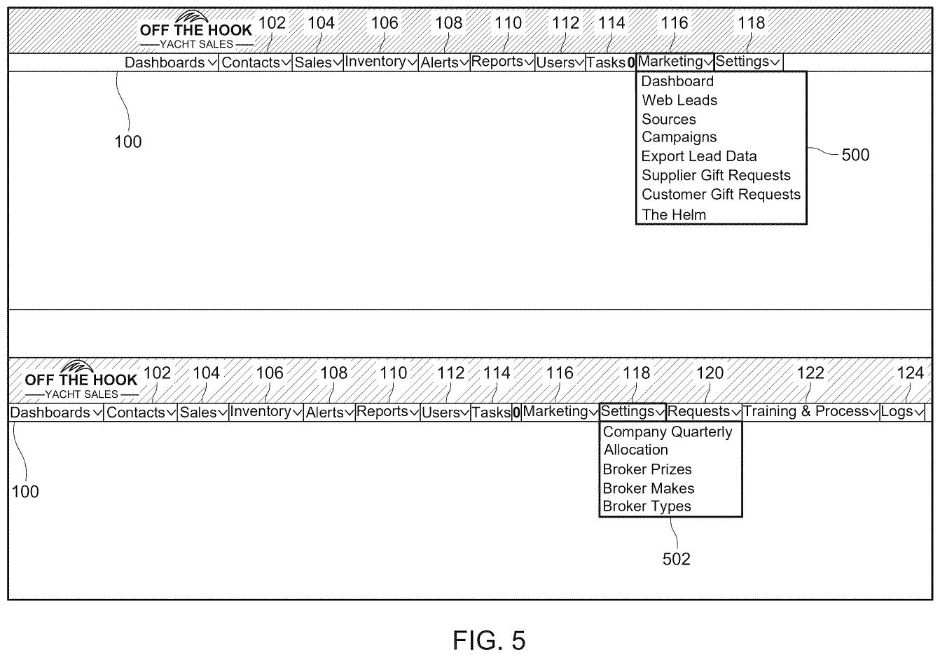

FIG. 5 is a screenshot of a dashboard GUI according to an embodiment of the subject matter described herein. Here, it may be appreciated that hovering the mouse over the Marketing tab displays a drop-down menu including Dashboard, Web Leads, Sources, Campaigns, Export Lead Data, Supplier Gift Requests, Customer Gift Requests, and The Helm that, when selected, take the user to an interface associated with these items. Additionally, the Settings tab include selections for Company Quarterly Allocation, Broker Prizes, Boat Makes, and Boat Types.

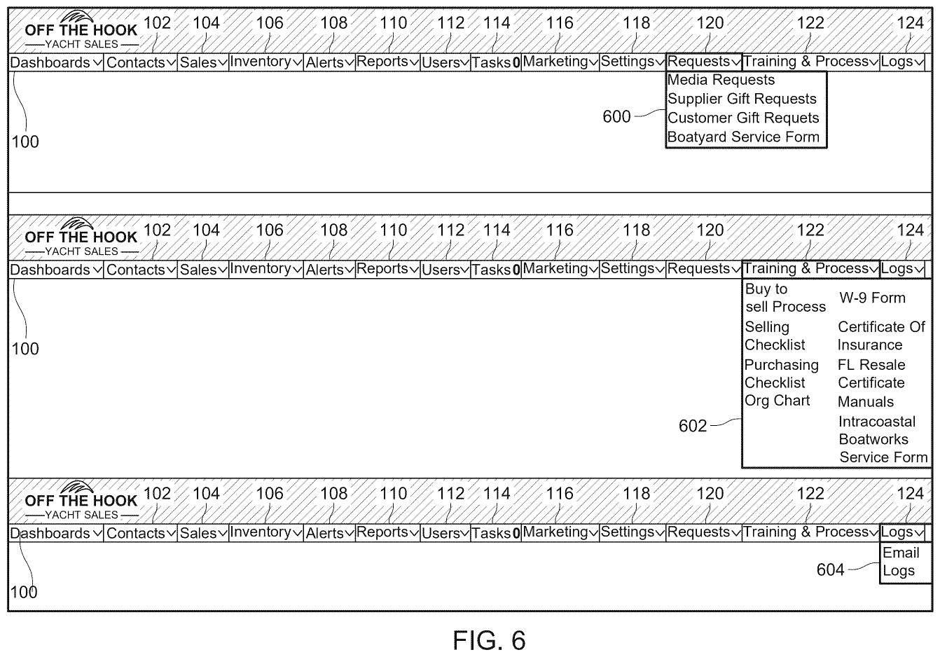

FIG. 6 is a screenshot of a dashboard GUI according to an embodiment of the subject matter described herein. Here, it may be appreciated that hovering the mouse over the Requests tab displays a drop-down menu including Media Requests, Supplier Gift Requests, Customer Gift Requests, and Boatyard Service Form that, when selected, take the user to an interface associated with these items. Additionally, the Training & Processes tab includes selections for Buy to Sell Process, Selling Checklist, Purchasing Checklist, Org Chart, W-9 Form, Certificate of Insurance, FL Resale Certificate, Manuals, and Intracoastal Boatworks Service Form. The Logs tab shows a selection for Email Logs.

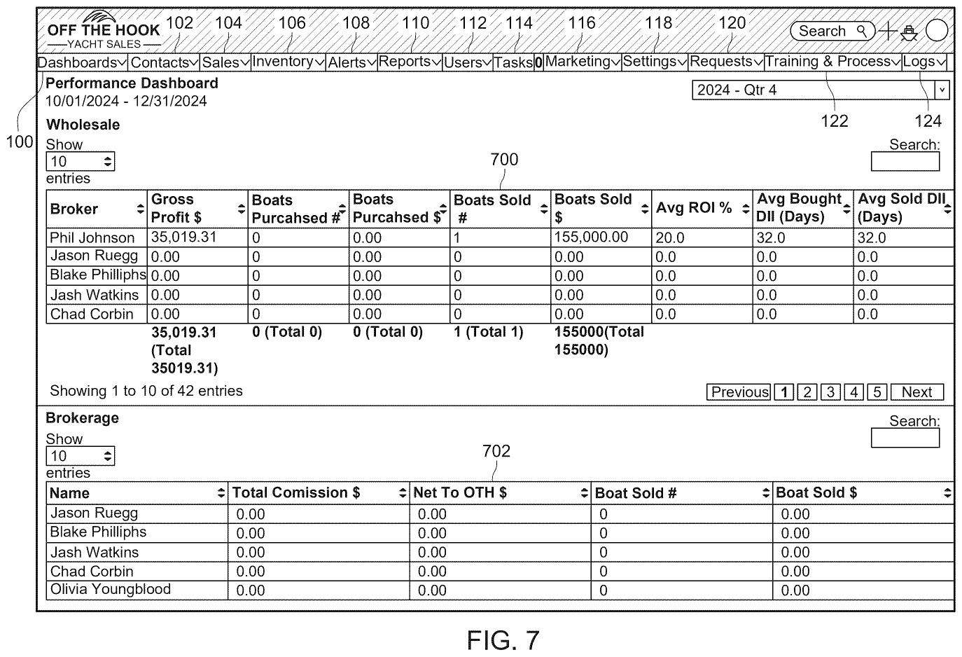

FIG. 7 is a screenshot of a Performance Dashboard GUI according to an embodiment of the subject matter described herein. Here, the upper portion displays various data associated with Wholesale and the lower portion displays various data associated with Brokerage. The Wholesale data includes the Broker, Gross Profit, Number of Boats Purchased, Number of Boats Sold, Amount of Boats Sold, Average Return on Investment, Average Bought DII (Days) and Average Sold DII (Days). The Brokerage data includes Names, Total Commissions, Net to OTH, number of Boats Sold, and Amount of Boats Sold.

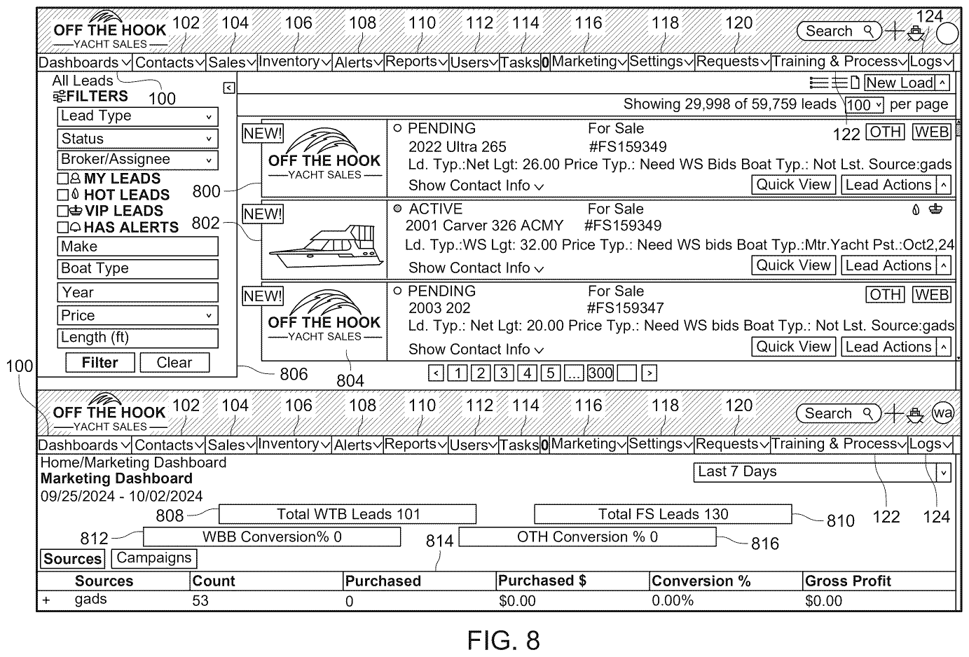

FIG. 8 is a screenshot of a dashboard GUI according to an embodiment of the subject matter described herein. Here, All Leads may be filtered based on a variety of criteria such as lead type, status, broker, make, boat type, year, price, and length. Several example Leads are shown for illustrative purposes. The first lead is for a 2022 Ultra 265 and allows the user to click on either Quick View or Lead Actions. Additionally, the Marketing Dashboard shown illustrates detailed information that may be presented to the user upon selection of the Marketing Dashboard drop-down menu. It shows, for example, total leads and conversion percentages.

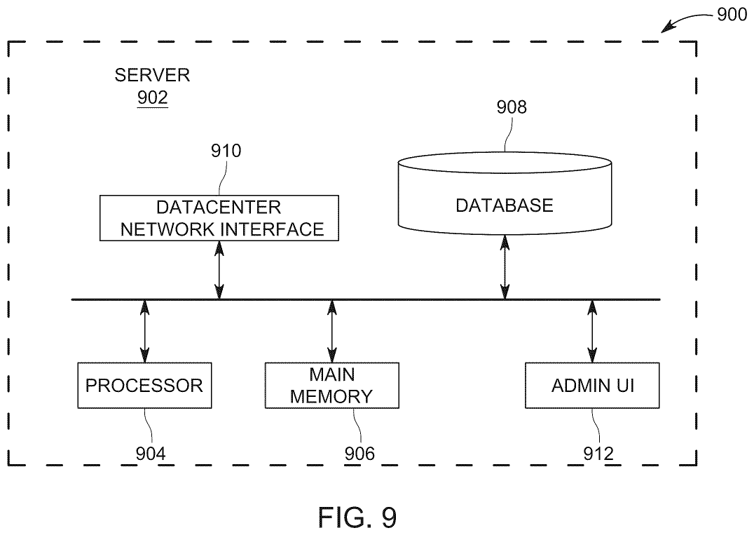

FIG. 9 depicts a block diagram 900 illustrating a server 902 as one example for implementing the methods in the present disclosure in accordance with embodiments of the present disclosure. The server 902 includes at least one of processor 904, a main memory 906, a storage memory (e.g., database) 908, a datacenter network interface 910, and an administration user interface (UI) 912. The server 902 may be configured to host an Ubuntu® server. In some embodiments Ubuntu® server may be distributed over a plurality of hardware servers using hypervisor technology.

The processor 904 may be a multi-core server class processor suitable for hardware virtualization. The processor may support at least a 64-bit architecture and a single instruction multiple data (SIMD) instruction set. The main memory 906 may include a combination of volatile memory (e.g., random access memory) and non-volatile memory (e.g., flash memory). The database 908 may include one or more hard drives.

The datacenter network interface 910 may provide one or more high-speed communication ports to the data center switches, routers, and/or network storage appliances. The datacenter network interface 910 may include high-speed optical Ethernet, InfiniBand (IB), Internet Small Computer System Interface (iSCSI), and/or Fibre Channel interfaces. The administration UI may support local and/or remote configuration of the server 902 by a datacenter administrator.

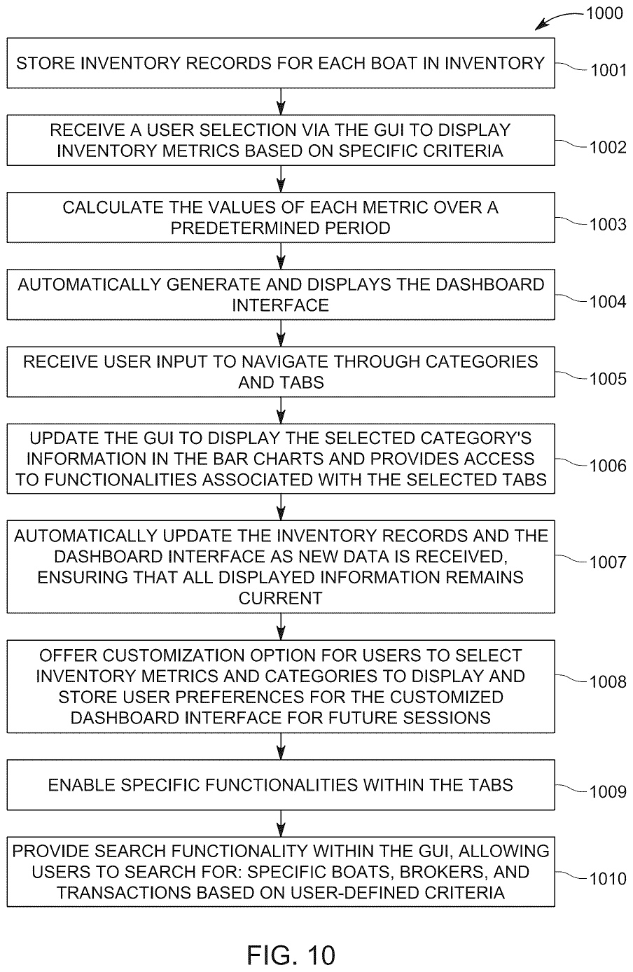

FIG. 10 depicts a flowchart illustrating the method steps for managing used boat inventory and displaying inventory metrics on a GUI in accordance with embodiments of the present disclosure. Referring to the flowchart in FIG. 10, the method for managing used boat inventory and displaying inventory metrics involves the following steps:

At block 1001, the system stores inventory records for each boat in inventory. Each record includes: Purchase Details indicating a purchase date and purchase price, Status Information indicating a current status and assigned broker, Financial Data displaying an amount of cash invested, floorplan financing details, and investor contributions, and Classification Data displaying categories such as wholesale, leads, bids, most recent incoming boats, and most recent outgoing boats.

At block 1002, the system receives a user selection via the GUI to display inventory metrics based on specific criteria, including: Number of purchased boats, Number of sold boats, Amount of cash invested in boats, Amount of money in floorplans, and Amount of money from investors.

At block 1003, the processor calculates the values of each metric over a predetermined period. This involves aggregating data from inventory records to provide accurate and up-to-date metrics.

The processor calculates the values of the selected metrics over a predetermined period by aggregating data from the inventory records. This ensures that users receive accurate and up-to-date information. In one embodiment, the processor generates predictive analytics based on historical inventory data to forecast future sales and inventory needs. This feature helps users anticipate market trends and make informed decisions. In another embodiment, the processor further generates predictive analytics based on historical inventory data to forecast future sales and inventory needs. This predictive feature enables users to anticipate market trends and make informed decisions regarding inventory management and sales strategies.

At block 1004, the system automatically generates and displays the dashboard interface. This includes providing Bar Charts of Metrics that are displayed for each individual broker over the selected time period. Category Bar Charts display categories such as Wholesale, Leads, Bids, most recent incoming boats, and most recent outgoing boats. Navigation Tabs are a set of tabs including Contacts, Sales, Inventory, Alerts, Reports, Users, Tasks, Marketing, Settings, Requests, Training, and Logs, each leading to a separate page with specific functionality.

At block 1005, the system receives user input to navigate through categories and tabs. Users can select different categories or tabs to view corresponding data or access various modules.

At block 1006, the system updates the GUI to display the selected category's information in the bar charts and provides access to functionalities associated with the selected tabs.

At block 1007, the system automatically updates the inventory records and the dashboard interface as new data is received, ensuring that all displayed information remains current.

In one embodiment, the method further comprises integrating inventory data with external platforms, including online marketplaces and dealer networks, and synchronizing data in real-time. This integration ensures consistency of inventory information across platforms and expands the reach to potential buyers.

The system continuously updates inventory records and the dashboard interface as new data is received, ensuring all information is current.

In one embodiment, the system integrates with external platforms, including online marketplaces and dealer networks, synchronizing inventory data in real-time. This integration expands market reach and ensures consistency across platforms.

At block 1008, the system offers customization options, allowing users to select which inventory metrics and categories are displayed and store user preferences for the customized dashboard interface for future sessions.

At block 1009, the system enables specific functionalities within the tabs. A Contacts Tab accesses a contact management module to add, edit, and track interactions with clients, brokers, and investors. A Sales Tab provides: Real-time tracking of sales opportunities, including status updates, projected closing dates, and sales pipeline analytics. An Alerts Tab provides Automated notifications regarding significant events such as new leads, bids, or changes in inventory status. A Reports Tab provides customizable reporting tools to create and save reports based on selected inventory metrics and time periods. A Users Tab provides user management functionality allowing administrators to assign roles and permissions. A Marketing Tab provides tools to create and manage marketing campaigns targeting potential buyers based on inventory data.

In one embodiment, enabling specific functionalities within the tabs further includes providing, via the Tasks tab, task management functionality. This allows users to create, assign, and track tasks related to inventory management and sales activities, enhancing team collaboration and efficiency.

In one embodiment, enabling specific functionalities within the tabs further includes providing, via the Training tab, access to a training module offering tutorials, documentation, and support resources. This assists users in effectively utilizing all features of the system.

At block 1010, the system provides search functionality within the GUI, allowing users to search for: Specific boats, Brokers, and Transactions based on user-defined criteria. This feature enhances user experience by facilitating quick access to relevant information.

In one embodiment, the method further comprises generating and displaying a heat map visualization of sales activity across different regions based on location data associated with inventory records. This visual representation helps users identify high-performing areas and focus marketing and sales efforts accordingly.

In one embodiment, the processor analyzes historical inventory data to forecast future sales trends. This involves statistical modeling and machine learning algorithms to predict inventory needs, helping users optimize stock levels and anticipate market demand.

In one embodiment, the system connects with external platforms through APIs, allowing real-time synchronization of inventory data. This ensures that listings on online marketplaces and dealer networks are always up-to-date, increasing exposure and sales opportunities.

In one embodiment, the Tasks tab provides tools for users to manage tasks efficiently. Users can assign tasks to team members, set deadlines, and monitor progress, enhancing collaboration and productivity within the organization.

In one embodiment, the Training tab offers a comprehensive resource center. Users can access video tutorials, step-by-step guides, and FAQs to learn how to utilize various features of the system, ensuring a smooth onboarding process and continuous learning.

In one embodiment, the system aggregates location-based sales data to create a heat map. This visual tool highlights regions with high sales activity, enabling users to identify lucrative markets and tailor their marketing strategies accordingly.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

ML is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, in which certain metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The system disclosed herein may be implemented as a client/server type architecture but may also be implemented using other architectures, such as cloud computing, software as a service model (SaaS), a mainframe/terminal model, a stand-alone computer model, a plurality of non-transitory lines of code on a computer readable medium that can be loaded onto a computer system, a plurality of non-transitory lines of code downloadable to a computer, and the like.

The system may be implemented as one or more computing devices that connect to, communicate with and/or exchange data over a link that interact with each other. Each computing device may be a processing unit-based device with sufficient processing power, memory/storage and connectivity/communications capabilities to connect to and interact with the system. For example, each computing device may be an Apple iPhone or iPad product, a Blackberry or Nokia product, a mobile product that executes the Android operating system, a personal computer, a tablet computer, a laptop computer and the like and the system is not limited to operate with any particular computing device. The link may be any wired or wireless communications link that allows the one or more computing devices and the system to communicate with each other. In one example, the link may be a combination of wireless digital data networks that connect to the computing devices and the Internet. The system may be implemented as one or more server computers (all located at one geographic location or in disparate locations) that execute a plurality of lines of non-transitory computer code to implement the functions and operations of the system as described herein. Alternatively, the system may be implemented as a hardware unit in which the functions and operations of the back-end system are programmed into a hardware system. In one implementation, the one or more server computers may use Intel® processors, run the Linux operating system, and execute Java, Ruby, Regular Expression, Flex 4.0, SQL etc.

In some embodiments, each computing device may further comprise a display and a browser application so that the display can display information generated by the system. The browser application may be a plurality of non-transitory lines of computer code executed by a processing unit of the computing device. Each computing device may also have the usual components of a computing device such as one or more processing units, memory, permanent storage, wireless/wired communication circuitry, an operating system, etc.

The system may further comprise a server (that may be software based or hardware based) that allows each computing device to connect to and interact with the system such as sending information and receiving information from the computing devices that is executed by one or more processing units. The system may further comprise software-or hardware-based modules and database(s) for processing and storing content associated with the system, metadata generated by the system for each piece of content, user preferences, and the like.

In one embodiment, the system includes one or more processors, server, clients, data storage devices, and non-transitory computer readable instructions that, when executed by a processor, cause a device to perform one or more functions. It is appreciated that the functions described herein may be performed by a single device or may be distributed across multiple devices.

When a user interacts with the system, the user may use a frontend client application. The client application may include a graphical user interface that allows the user to select one or more digital files. The client application may communicate with a backend cloud component using an application programming interface (API) comprising a set of definitions and protocols for building and integrating application software. As used herein, an API is a connection between computers or between computer programs that is a type of software interface, offering a service to other pieces of software. A document or standard that describes how to build or use such a connection or interface is called an API specification. A computer system that meets this standard is said to implement or expose an API. The term API may refer either to the specification or to the implementation.

Software-as-a-service (SaaS) is a software licensing and delivery model in which software is licensed on a subscription basis and is centrally hosted. SaaS is typically accessed by users using a thin client, (e.g., via a web browser). SaaS is considered part of the nomenclature of cloud computing.

Many SaaS solutions are based on a multitenant architecture. With this model, a single version of the application, with a single configuration (hardware, network, operating system), is used for all customers (“tenants”). To support scalability, the application is installed on multiple machines (called horizontal scaling). The term “software multitenancy” refers to a software architecture in which a single instance of software runs on a server and serves multiple tenants. Systems designed in such manner are often called shared (in contrast to dedicated or isolated). A tenant is a group of users who share a common access with specific privileges to the software instance. With a multitenant architecture, a software application is designed to provide every tenant a dedicated share of the instance-including its data, configuration, user management, tenant individual functionality and non-functional properties.

The backend cloud component described herein may also be referred to as a SaaS component. One or more tenants which may communicate with the SaaS component via a communications network, such as the Internet. The SaaS component may be logically divided into one or more layers, each layer providing separate functionality and being capable of communicating with one or more other layers.

Cloud storage may store or manage information using a public or private cloud. Cloud storage is a model of computer data storage in which the digital data is stored in logical pools. The physical storage spans multiple servers (sometimes in multiple locations), and the physical environment is typically owned and managed by a hosting company. Cloud storage providers are responsible for keeping the data available and accessible, and the physical environment protected and running. People and/or organizations buy or lease storage capacity from the providers to store user, organization, or application data. Cloud storage services may be accessed through a co-located cloud computing service, a web service API, or by applications that utilize the API.

1. A system for managing used boat inventory records by tracking and displaying inventory metrics, the system comprising:
a memory and processor configured to perform the steps of:
creating an inventory record for each boat in inventory;
adding classification data relating to each boat;
adding financial data relating to each boat;
generating bar charts and reports based on the inventory records, displaying metrics for each individual broker over a period of time on a dashboard interface;
automatically updating the inventory records and the dashboard interface as new data is received to thereby the used boat inventory; and
providing navigation through a set of tabs where each tab leads to a separate page with specific functionality.

2. The system of claim 1, wherein the processor is further configured to generate predictive analytics based on historical inventory data to forecast future sales and inventory needs.

3. The system of claim 1, wherein a Reports tab provides customizable reporting tools allowing users to create and save custom reports based on selected inventory metrics and time periods.

4. The system of claim 1, wherein a Users tab includes user management functionality allowing administrators to assign roles and permissions to different users of the system.

5. The system of claim 1, wherein a Marketing tab allows users to create and manage marketing campaigns targeting potential buyers based on inventory data.

6. The system of claim 1, further comprising an integration module configured to synchronize inventory data with external platforms such as online marketplaces or dealer networks.

7. The system of claim 1, wherein the system is further configured to allow users to customize the dashboard interface by selecting which inventory metrics and categories are displayed.

8. The system of claim 1, wherein the system stores user preferences for the customized dashboard interface and automatically applies them upon user login.

9. The system of claim 1, wherein a Contacts tab provides access to a contact management module allowing users to add, edit, and track interactions with clients, brokers, and investors.

10. The system of claim 1, wherein a Sales tab provides real-time tracking of sales opportunities, including status updates, projected closing dates, and sales pipeline analytics.

11. The system of claim 1, wherein an Alerts tab provides automated notifications to users regarding significant events, including new leads, bids, or changes in inventory status.

12. A method of displaying used boat inventory metrics on a graphical user interface (GUI) of a computer system, the method comprising:
receiving, via the GUI, a user selection to display inventory metrics based on specific criteria;
determining, by a processor, the values of each metric over a predetermined period of time;
automatically generating and displaying bar charts of the metrics on a dashboard interface of the GUI, wherein the bar charts are displayed for each individual broker over the predetermined period of time;
receiving user input to navigate through categories;
updating the GUI to display the selected category's information in the bar charts.

13. The method of claim 12, further comprising allowing the user to export the displayed inventory metrics and bar charts to a report in a selectable format including PDF, Excel, or CSV.

14. The method of claim 12, wherein determining the values of each metric further comprises aggregating data from multiple data sources including internal databases and external market data feeds.

15. The method of claim 12, further comprising providing interactive bar charts that allow the user to select a segment of the bar chart to view detailed information about that metric.

16. The method of claim 12, further comprising sending automated notifications to brokers when certain inventory metrics reach predefined thresholds.

17. The method of claim 12, wherein the GUI includes a search function allowing the user to search for specific boats, brokers, or transactions based on user-defined criteria.

18. A computer-readable medium storing instructions for managing used boat inventory, the instructions comprising:
receiving and storing data related to boat transactions, including data for purchased boats, sold boats, cash in boats, floorplan financing, and investor funds;
automatically generating bar charts and visual summaries for:
wholesale, leads, bids, most recent incoming boats, and most recent outgoing boats, for each broker over a specified period;
providing a user interface comprising multiple tabs, each configured to:
display relevant data and metrics for contacts, sales, inventory, alerts, reports, users, tasks, marketing, settings, requests, training, and logs; and
enabling updates and dynamic visualizations on a dashboard for the tracked metrics.

19. A system for tracking and managing boat inventory through a user interface, comprising:
a non-transitory computer-readable medium containing instructions executable by a processor, wherein the instructions are configured to:
track data related to the purchase and sale of boats, cash in boats, money in floorplans, and investor funds;
update and display visual summaries of wholesale, leads, bids, incoming and outgoing boats for each broker;
a processor programmed to:
execute instructions for generating a dashboard view comprising visual metrics and dynamic bar charts;
manage separate data categories through multiple interface tabs, including contacts, sales, inventory, alerts, and reports; and
a user interface allowing brokers to input and review boat inventory data, with automated updates to the dashboard for real-time tracking.
